(19) United States
(12) Patent Application Publication
(10) Pub. No.: US 2007/0081490 A1
(43) Pub. Date: Apr. 12, 2007

(54) Channel time allocating method using ECAP in wireless personal area network

(76) Inventors: Ji-Eun Kim, Daejon (KR); Young-Ae Chun, Daejon (KR); Sang-Jae Lee, Daejon (KR); Sang-Sung Choi, Daejon (KR)

Correspondence Address: LADAS & PARRY LLP, 224 SOUTH MICHIGAN AVENUE, SUITE 1600, CHICAGO, IL, 60604, US

(21) Appl. No.: 11/455,409

(22) Filed: Jun. 19, 2006

(30) Foreign Application Priority Data
Oct. 6, 2005 (KR) 10-2005-0093998

(51) Int. Cl. H04Q 7/00

(52) U.S. Cl. 370/329; 370/428; 370/448; 370/431

(57) ABSTRACT

Provided is a channel time allocating method using Extended Contention Access Period (ECAP) in a wireless personal area network (WPAN). The method includes the steps of: a) receiving channel time allocation requests for data transmission from the Devices; and b) allocating channel time upon the channel time allocation request of the Devices and allocating a rest time period which are left behind after channel time allocation to the Devices as the ECAPs for competitive use of the Devices. The method can be used to allocate the channel time in the WPAN.

### FIELD OF THE INVENTION

The present invention relates to a channel time allocating method using Extended Contention Access Period (ECAP) in a wireless personal area network (WPAN); and, more particularly, to a channel time allocating method that can improve a quality of service (QoS) of isochronous stream and raise the applicability of a channel by making a period which is not allocated to a device in a super frame in a WPAN, be competitively used by devices such as Contention Access Period (CAP).

### DESCRIPTION OF RELATED ART

There are a contention period of a Carrier Sense Multiple Access/Collision Avoidance (CSMA/CA) scheme and a contention-free period of a Time Division Multiple Access (TDMA) scheme in an Institute of Electrical and Electronics Engineers (IEEE) 802.15.3 protocol. Herein, the contention-free period has a slot allocated to each stream for stream transmission of each device and each device should transmit its own transmission stream at an allocated channel time. The allocated channel time can be changed every super frame period and the changed time slot can be known through beacon frame information.

When stream to be transmitted is generated, the device is allocated with channel time from Piconet Coordinator (PNC). When stream transmission is completed and it is not necessary to use the allocated channel time, the device requests the PNC to retract the channel time. The PNC receives a request for allocation and retraction of the channel time from the device and manages the channel time in the super frame. Herein, the channel of the retracted channel time period remains vacant until allocation of new channel time is request.

The device requests sufficient time in the request of the channel allocation, but frame transmission cannot be completed within allocated channel time in case that a wireless channel condition is poor. When the wireless channel condition is poor and the transmission of an isochronous stream is not completed within the channel time, there is a problem that the Quality of Service (QoS) cannot be secured.

Also, when the channel is not allocated, a response cannot be quickly transmitted since a high layer reliable protocol requires a process of requesting the channel allocation. Accordingly, there is a problem that channel applicability is decreased since the channel is occasionally used for channel allocation.

When a Contention Access Period (CAP), which is basically allocated, is used for the high layer reliable protocol, there is a problem that response time can be delayed since a channel is acquired through contention.

### SUMMARY OF THE INVENTION

It is, therefore, an object of the present invention to provide a channel time allocating method using Extended Contention Access Period (ECAP) to improve a quality of service (QoS) of isochronous stream and raise a channel applicability by making a period which is not allocated to devices in a super frame of Wireless Personal Area Network (WPAN) such as Contention Access Period (CAP)be used competitively by the devices.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a channel time allocating method in the WPAN including Piconet Coordinator (PNC) and a plurality of devices, the method including the steps of: a) receiving channel time allocation requests for data transmission from the devices; and b) allocating channel time upon the channel time allocation requests of the devices and allocating rest time periods which are left behind after channel time allocation to the devices as the ECAPs for competitive use of the devices.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram showing channel time allocated in a super frame of a conventional IEEE802.15.3 protocol;

FIG. 2 is a diagram showing channel time allocated in a super frame in accordance with an embodiment of the present invention;

FIG. 3 is a diagram showing allocated channel time and non-allocated channel time in accordance with the embodiment of the present invention;

FIG. 4 is a flowchart describing a method transmitting a frame by using a Contention Access Period (CTA) and the Extended Contention Access Period (ECAP) in a device of the present invention;

FIG. 5 is a flowchart describing a method for receiving a frame in channel time in the device of the present invention;

FIG. 6 is a flowchart describing a method for transmitting a frame through a backoff process in ECAP in accordance with an embodiment of the present invention;

FIG. 7 is a diagram showing a frame of the IEEE802.15.3 protocol; and

FIG. 8 is a diagram showing a beacon frame of the IEEE802.15.3 protocol.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

The present invention allocates Extended Contention Access Period (ECAP) other than a basic Contention Access Period (CAP) in the inside of a super frame and transmits isochronous stream and asynchronous frame based on the ECAP to thereby provide a channel allocating method which can improve a quality of service and support a high layer reliable protocol.

The present invention is a channel time allocating method in a wireless personal area network (WPAN) including a Piconet Coordinator (PNC) and a plurality of devices. The present invention includes the steps of receiving a channel time allocation request for transmitting data from the devices, allocating the channel time based on the request from the devices and allocating a time period which is left behind after time period allocation to the devices as an ECAP which the devices can competitively use. The channel time allocating step will be described in detail hereinafter.

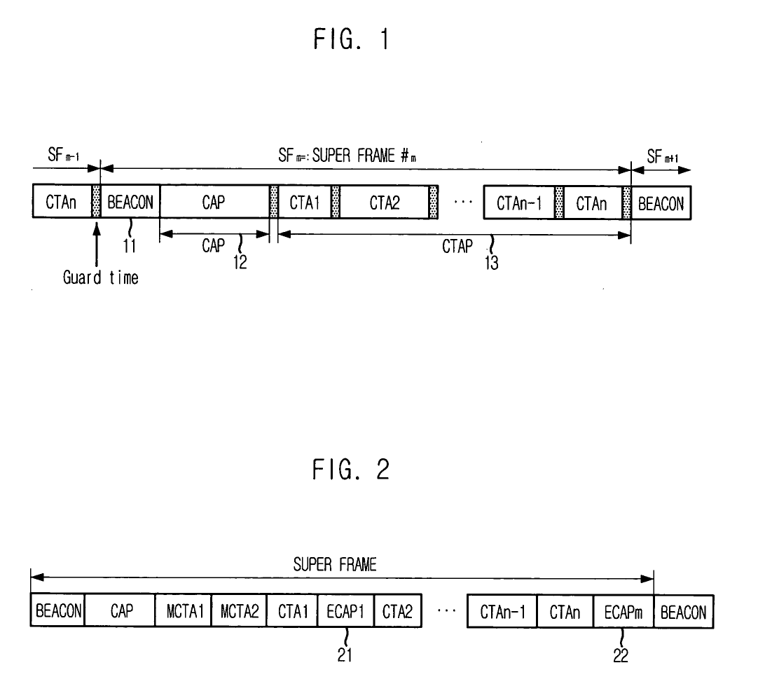

FIG. 1 is a diagram showing channel time allocated in a super frame of a conventional IEEE802.15.3 protocol. FIG. 2 is a diagram showing channel time allocated in a super frame in accordance with an embodiment of the present invention.

As shown in FIG. 1, the channel time of the super frame in the IEEE802.15.3 protocol includes a beacon 11, a CAP 12 and a Channel Time Allocation Period (CTAP) 13. The beacon 11 has diverse informations required for timing allocation, such as displaying CAP ending time, and information required for the Piconet Coordinator (PNC) to manage all devices by.

The present invention allocates a period which is not allocated as the CTA in a structure of the conventional channel time of FIG. 1 or a CTA whose usage ending is notified by the device as ECAPs 21 and 22 instead of leaving them alone before receiving a request to allocate them as a new CTA.

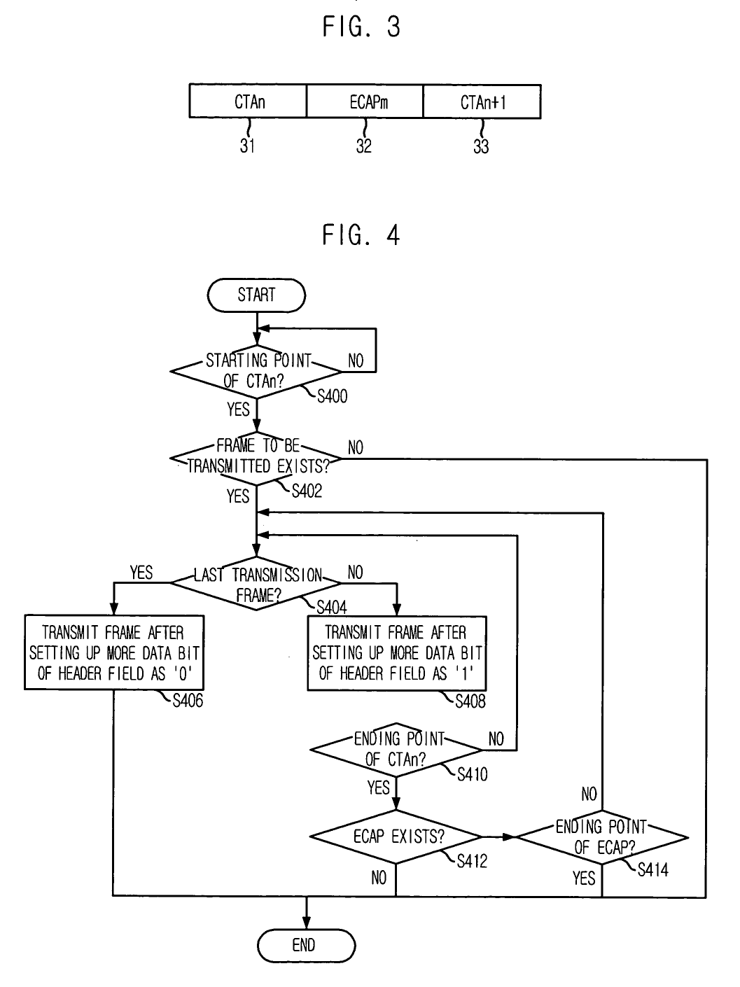

FIG. 3 is a diagram showing allocated channel time and non-allocated channel time in accordance with an embodiment of the present invention.

FIG. 3 shows CTAs 31, 33 and a ECAP 32. The CTAs 31 and 33 are channel times which are allocated by receiving a request from a device. The ECAP 32 is a period which is not allocated to the device. A method for improving the QoS by using the ECAP will be described in detail through FIGS. 4 to 6.

In FIG. 3, the device allocated with the CTAn 31 has a priority to use an ECAPm 32 and other devices can use the ECAPm 32 during the rest time by the Carrier Sense Multiple Access/Collision Avoidance (CSMA/CA) method such as the CAP.

FIG. 4 is a flowchart describing a method for transmitting a frame by using the CTA and the ECAP in a device of the present invention. It shows a process that the device transmits the frame by using all of the allocated CTA and ECAP when there is the ECAP after the CTA allocated to the device.

The device waits for a starting point of the allocated CTAn at step S400 and checks at step S402 whether there are frames to be transmitted when the CTA starts.

When it turns out that there is no frame to be transmitted, the logic flow ends, but when there are frames to be transmitted, the device starts to transmit the frames.

It is checked at step S404 during frame transmission whether the transmission frame is the last frame. When the frame to be transmitted is the last frame to be transmitted in the CTA, the frame is transmitted by setting up ‘More data’ bit of a frame control field among frame headers as ‘0’ at step S406.

When the frame to be transmitted is not the last frame, the ‘More data’ bit of the frame control field among the frame headers is set up as ‘1’ at step S408. Subsequently, the frame is transmitted at step S410 by repeating the above processes until the CTAn ending time.

When all of the frames to be transmitted are not transmitted by the CTAn ending time, it is checked at step S412 whether a period next to the allocated CTA is the ECAP. When it is turned out that the period next to the CTA is the ECAP, frames are continuously transmitted at step S414 until the ECAP ends.

When all of the frames to be transmitted are transmitted by the ECAP ending time at steps S414 and S404, frame transmission completion is notified to the reception device by setting up the More data bit as ‘0’.

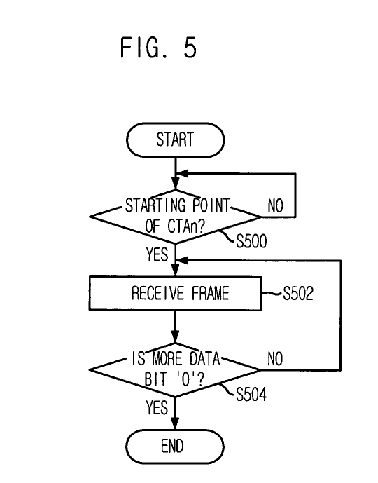

FIG. 5 is a flowchart describing a method for receiving a frame in channel time in the device of the present invention. It shows a process receiving a frame in the CTAn.

When the CTAn starts at step S500, the reception device receives a frame in the CTAn at step S502. The reception device checks during receiving the frame at steps S504 whether ‘More data’ bit of a frame control field among frame headers is ‘0’.

The reception device continuously receives the frame until a frame, in which the ‘More data’ bit is set up as ‘0’, is transmitted. In the present invention, the device continuously receives the frame until the frame whose ‘More data’ bit is set up as ‘0’ is transmitted since it is possible to receive the frame in the ECAP although the CTAn ends.

When the frame whose ‘More data’ bit is set up as ‘0’ is received, the frame reception ends.

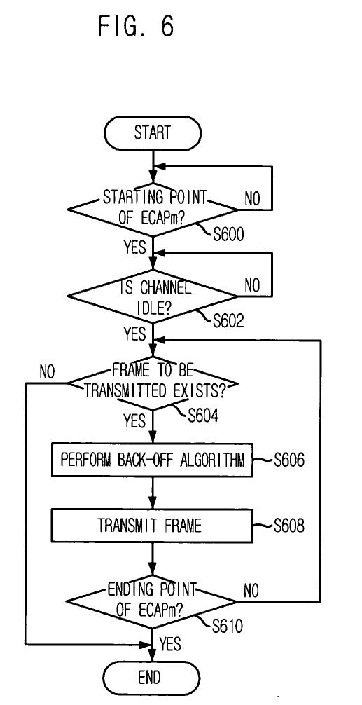

FIG. 6 is a flowchart describing a method for transmitting a frame through a backoff process in ECAP in accordance with the embodiment of the present invention. It shows a process transmitting a frame by using the ECAP, which is channel time except allocated channel time.

The ECAP is not the channel time allocated to a specific device, but a period for transmitting a frame by a device acquiring a channel through competitiveness such as a CAP method. Accordingly, when the ECAP starts at step S600, devices to transmit a frame wait at step S602 until the channel becomes idle.

When the channel becomes idle and there is a frame to be transmitted at step S604, the device performs a back-off algorithm at step S606 and device acquiring a channel through the back-off algorithm transmits the frame at step S608. The back-off algorithm is performed every frame.

A process transmitting/receiving a frame is repeated by competitively acquiring a channel through the back-off algorithm until the ECAP ends at step S610.

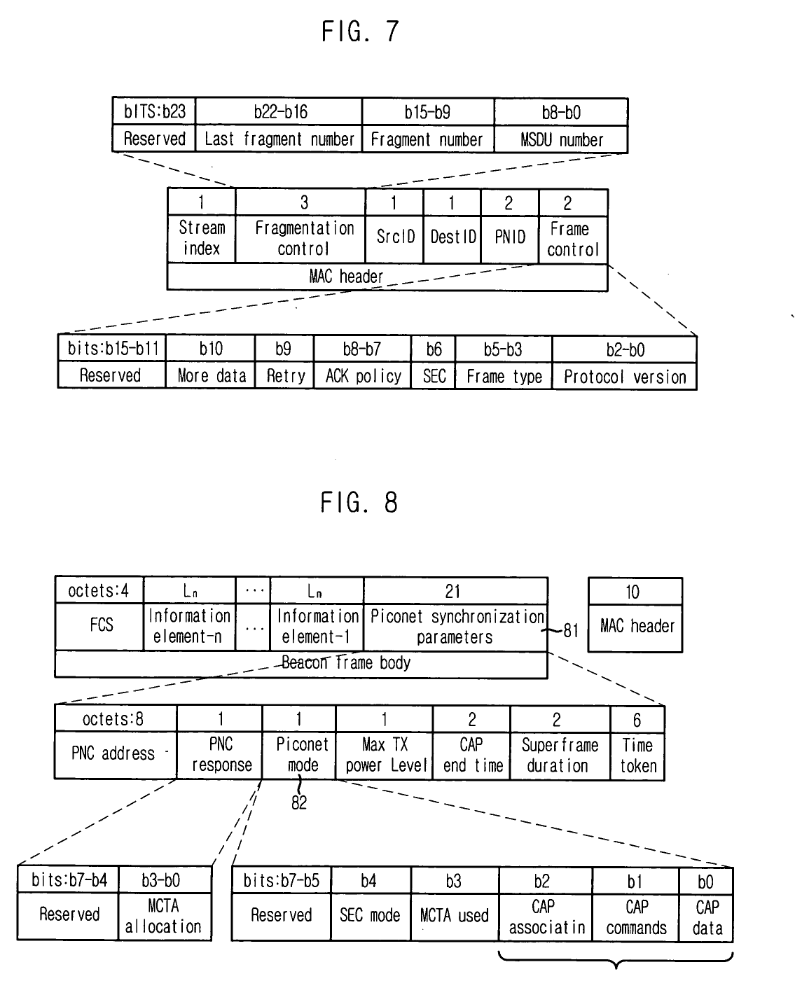

FIG. 7 is a diagram showing a frame of an IEEE802.15.3 protocol and FIG. 8 is a diagram showing a beacon frame of an IEEE802.15.3 protocol. Since the frames have a standard size, detailed description will not be provided herein.

In the present invention, a transmissible frame type in the ECAP follows information of a Piconet mode field 82 of a Piconet synchronization parameter field 81 in the inside of a beacon frame.

The present invention can improve the QoS of the isochronous stream and raise the channel applicability, i.e., reduce the wasteful use of the channel by using the period, which is not allocated to the CTA in the inside of the super frame of the WPAN. Also, the present invention can support the high layer reliable protocol such as the TCP response frame without additional channel allocation.

That is, the present invention has diverse devices competitively use the rest channel time except the channel time, which is allocated by the request from the device, through the back-off algorithm, to thereby raise the efficiency of the channel.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application No. 2005-0093998, filed with the Korean Intellectual Property Office on Oct. 6, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A channel time allocating method in a Wireless Personal Area Network (WPAN) including Piconet Coordinator (PNC) and a plurality of devices, comprising the steps of:
a) receiving channel time allocation requests for data transmission from the devices; and
b) allocating channel time upon the channel time allocation requests of the devices and allocating rest time periods which are left behind after channel time allocation to the devices as Extended Contention Access Periods (ECAP) for competitive use of the devices.

2. The method as recited in claim 1, wherein the device receiving Channel Time Allocation (CTA) before the ECAP has a priority to use the ECAPs and the rest ECAPs which are not used by the device having the priority to use be competitively used by other devices through a back-off process.

3. The method as recited in claim 2, wherein in the ECAP, the device allocated with the CTA before the ECAP can transmit a frame until next ECAP ends when there are frames to be transmitted.

4. The method as recited in claim 2, wherein the rest ECAPs can be competitively used in a Carrier Sense Multiple Access/Collision Avoidance (CSMA/CA) method.

5. The method as recited in claim 2, wherein a transmissible frame type in the ECAP follows Piconet mode field information of a Piconet synchronous parameter field in a beacon frame.
